(19) United States
(12) Patent Application Publication
(10) Pub. No.: US 2007/0019077 A1
(43) Pub. Date: Jan. 25, 2007

(54) Portable surveillance camera and personal surveillance system using the same

(76) Inventor: Sang Rae Park, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/561,607

(22) PCT Filed: Jun. 7, 2004
(86) PCT No.: PCT/KR04/01356

§ 371 Date: Dec. 20, 2005

(30) Foreign Application Priority Data
Jun. 27, 2003 (KR) 10-2003-0042724

(51) Int. Cl. H04N 5/232

(52) U.S. Cl. 348/211.99

(57) ABSTRACT

A portable surveillance camera and a personal surveillance system are disclosed. More specifically, provided are a portable surveillance camera comprising a mini-camera such as a CMOS camera or a CCD camera, and a system for surveilling a predetermined place using the portable surveillance camera. The personal surveillance system receives multimedia data such as image, sound, event and control data on real time from the portable surveillance camera installed in various areas such as a house, a shop or an office with a control device connectable to a network such as a LAN or an internet, and then monitors or stores the multimedia data. Also, the personal surveillance system can search, surveille, control, edit and store multimedia data such as image, sound, event and control data for a desired period of time from data stored in the portable surveillance camera or the control device.

### TECHNICAL FIELD

The present invention generally relates to a portable surveillance camera and a personal surveillance system using the same, and more specifically, to a portable surveillance camera having an embedded mini-camera such as a CMOS camera or a CCD camera, and a system for surveilling a specific place using the portable surveillance camera. Also, the present invention relates to a personal surveillance system for receiving multimedia data such as image, sound, event and control data on real time from a portable surveillance cameras installed in various areas such as a house, a store, an office with a control device connectable to a network (i.e., LAN, intemet, etc.) to monitor or store the multimedia data, for searching, surveilling, controlling, editing and storing multimedia data (i.e., image, sound, event, control data) for a desired period of time from the data stored in the portable surveillance camera or the control device.

### BACKGROUND ART

A closed circuit TV (abbreviated as “CCTV”) and a video cassette recorder (abbreviated as “VCR”) have been widely used as a conventional security and surveillance system. The VCR used for recording image in the CCTV receives an analog video signal as a PAL or NTSC type from a surveillance camera, and processes the analog video signal to be recorded in a magnetic tape of a video cassette depending on a VHS or SVHS standard.

Since the conventional VCR records the received analog video signal as an analog recording signal on a basis of the analog recording standard, a video cassette tape is repeatedly used, which results in degradation of image quality, change of surveillance image, only support of sequential search, trouble in configuration with more than 3 equipments, inconvenience of recording tape and need of a resident surveillant.

A digital video recorder (abbreviated as “DVR”) is provided to solve the problems in a processing and storing method of an analog recording signal. Since the DVR is based on a digital data processing system, multi-channel video signals inputted from a plurality of video cameras are represented at one time on 4 or 16 screens obtained by dividing one monitor screen, or a screen of a desired surveillance area is displayed as a single screen on the whole screen of the monitor. As a result, it is easy to provide various functions in the DVR.

A detection sensor is installed to surveille the circumstance or intrusion of a foreigner in every surveillance place. When an event is detected through the detection sensor and an alarm is inputted while a surveillance area is displayed on the divided screens, it is easier to embody various functions such as an automatic conversion function to display a screen of a corresponding surveillance area by adding hardware and software to a dedicated control device. Also, it is possible to minimize storage capacity by applying image and sound information of the screen to an enhanced compression technique, and it is easy to store, keep and search data. As a result, the DVR has been widely distributed.

Although various technologies have been developed on a basis of processing of digital data for a security surveillance system, these surveillance systems have a limitation which depend on a method of receiving data such as image, sound and event signals by detection of a sensor on a wire from a plurality of surveillance cameras positioned in fixed locations in control devices such as a dedicated control device and of transmitting and receiving various control signals. Also, it is improper to use for personal surveillance systems which frequently move due to configuration of the systems and its size. For example, when a person who frequently moves intends to surveille various crimes or risks in a predetermined area where the person stays such as an office or a house, and to record the situation at emergency, the surveillance cameras should be installed in all areas where the person stays. As a result, excessive cost is required in installment and operation of the system so that it is impossible for a person to install and operate the system.

In order to solve the above-described problem, ‘a security system and method using a visual portable phone’ in the Korean Patent Application No. 10-1999-0052960 discloses a configuration where a sensor is mounted in a portable wireless phone having a camera which has been widely used to transmit data to a control device through a repeater and to contact with a security company at emergency.

However, the conventional system with a portable wireless phone having a camera and a wireless phone network have a limitation in transmission capacity of data. Additionally, while a user uses the basic functions of a phone such as calling and receiving a message, the user cannot use a surveillance function. Since data are transmitted to a central processing unit through a wireless phone network, the surveillance function cannot be performed in an area where connection of the wireless phone network is not smooth. Besides, it is difficult to unite various additional functions required in a surveillance camera because a wireless phone is used. Here, a system is required which includes a large-scaled server for receiving data through the wireless phone network and processing in the center. As a result, an operating subject cannot but be a large-scale communication company having a plurality of subscribers so that it is necessary to construct a large number of infrastructures before an individual can receive the service.

### BRIEF DESCRIPTION OF THE DRAWINGS

FIG. 1 is a block diagram illustrating a portable surveillance camera according to an embodiment of the present invention.

FIG. 2 is a block diagram illustrating a portable surveillance camera and an external extension apparatus connectable to the portable surveillance camera according to an embodiment of the present invention.

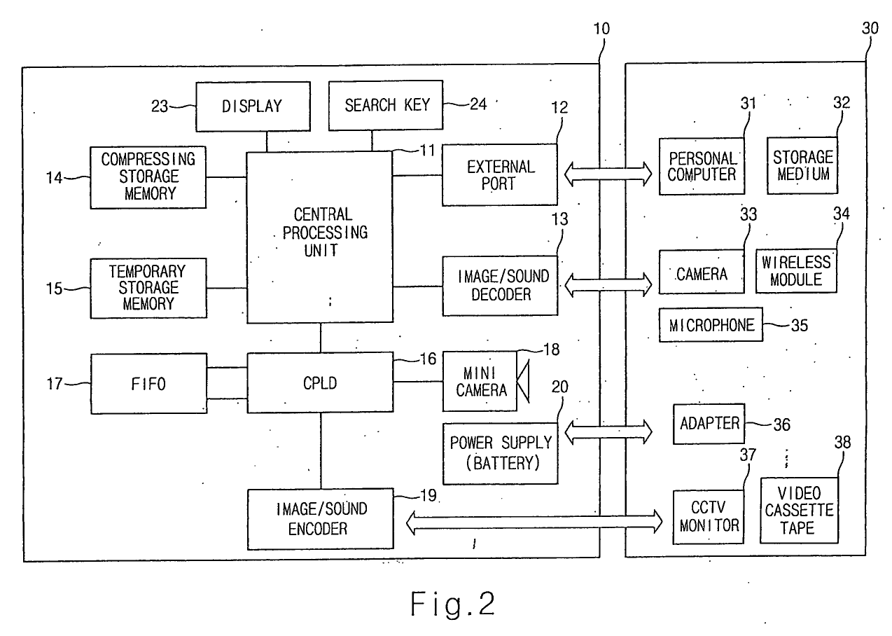

FIG. 3 is a block diagram illustrating an extensible function of a portable surveillance camera according to an embodiment of the present invention.

FIG. 4 is a wireless connection diagram illustrating a portable surveillance camera and a control device according to an embodiment of the present invention.

FIG. 5 is a flow chart illustrating the operation of a portable surveillance camera according to an embodiment of the present invention.

FIG. 6 is a flow chart illustrating the operation of a control device according to an embodiment of the present invention.

### DETAILED DESCRIPTION OF THE INVENTION

Technical Subject

In order to solve the above-described problems, it is an object of the present invention to provide a portable surveillance camera which is capable of being instantly installed in a desired location by person who frequently moves without installment of an additional security camera and a CCTV system, of being portable to be changed in its location and of being united into a personal surveillance camera dedicated device for embodiment of various functions such as addition of a sensor to be proper for personal surveillance, and a personal surveillance system using the same.

It is another object of the present invention to provide a portable surveillance camera having a function of storing multimedia data therein so that the data is stored and kept in a place having an unstable or incomplete network or wireless net, and a personal surveillance system using the same.

It is still another object of the present invention to provide a portable surveillance camera for transmitting and storing data by a local area wireless communication protocol to a control device on real time which has various functions performed in the portable surveillance camera except a control function so that the control device can perform a function of the surveillance camera if necessary, and a personal surveillance system using the same.

It is still another object of the present invention to provide a personal surveillance system which enables itself to surveille, search, control, edit and store data remotely through network such as LAN or intemet connected to the control device.

Technical Solution

In order to achieve the above-described objects, there is provided a personal surveillance system using a portable surveillance camera which comprises: one or more portable surveillance camera having a wireless communication function and capable of capturing a required image; and a control device for collecting the image captured from the portable surveillance camera through wireless communication and storing the collected image to perform a predetermined signal processing.

Preferably, the portable surveillance camera comprises: a camera unit for capturing the required image to perform a predetermined image processing; and a wireless module for providing a wireless communication function with the control device.

Preferably, the camera unit comprises: a mini-camera for capturing an image; a temporary storage memory for temporarily storing data outputted from the mini-camera; a central processing unit for compressing the data temporarily stored in the temporary storage memory; a compressing storage memory for storing data compressed by the central processing unit; a display for representing the stored image and a state of the camera in a screen; a searching unit for searching the data by representing the stored data through the display; and an external port for storing the data in an external storage unit or for providing connection to an external unit in order to download, search, store or process the data, which is stored in the compressing storage memory, in a personal computer.

Preferably, the camera unit further comprises an infrared LED for providing a light source for night photographing.

Preferably, the camera unit is capable of regulating a time interval for capturing an image to prevent power consumption.

Preferably, the camera unit has an automatic focus control function with respect to an object located at a distance of more than 40 cm.

Preferably, the control device comprises: a wireless module for providing a wireless communication function with the portable surveillance camera; a searching unit for accessing the portable surveillance camera through the wireless comprises: a sensor connection unit for connecting at least one or more sensors selected from movement, fire, heat, gas, door open and close sensors; and a unit for processing a signal inputted from the sensor and generating an event signal to provide a signal for controlling the operation of the alarm when a predetermined event is generated.

Preferably, the alarm further comprises a unit for generating an event while interworking with an external switch unit such as a bell.

Preferably, the alarm further comprises a unit for controlling setting/cancellation of the alarm function with a wireless remote control.

In an embodiment, there is provided a portable surveillance camera applied to a personal surveillance system, comprising: a camera unit for capturing a required image to perform a predetermined image processing; and a wireless module for transmitting and receiving wireless data externally.

Preferably, the camera unit comprises: a mini-camera for capturing an image; a temporary storage memory for temporarily storing data outputted from the mini-camera; a central processing unit for compressing data temporarily stored in the temporary storage memory; a compressing storage memory for storing the data compressed by the central processing unit; a display for representing the collected image and a state of the camera on a screen; a searching unit for representing the stored data through the display to search the data; and an external port for storing the data in an external storage unit or providing connection to an external unit to download, search, store or process the data, which is stored in the compressing storage memory, in a personal computer.

Preferably, the camera unit further comprises an image/sound decoder for decoding a received image and/or sound data, the temporary storage memory temporarily stores the image and/or sound data, the central processing unit compresses the image and/or sound data, and the compressing storage memory stores the compressed image and/or sound data.

Preferably, the camera unit further comprises: a FIFO memory for performing a buffer function; a CPLD module for temporarily storing and transmitting the data in the FIFO to adjust data input and output speed so that the data is read through an externally installed monitor; and an image/sound encoder(19) for outputting data received from the CPLD module to an external image processing unit.

Preferably, the camera unit further comprises a removable chipset memory for storing the compressed data.

Preferably, the camera unit further comprises a removable view finder for easily displaying a boundary of images captured by the mini-camera.

Preferably, the camera unit further comprises an infrared LED for providing a light source for night photographing.

Preferably, the camera unit is capable of regulating a time interval for capturing an image to prevent power consumption.

Preferably, the camera unit has an automatic focus control function with respect to an object located at a distance of more than 40cm.

In addition, the portable surveillance camera further comprises: a sensor connection unit for connecting at least one or more sensors selected from movement, fire, heat, gas, door open and close sensors; and a unit for processing a signal inputted from the sensor and generating an event signal to provide a signal for controlling the operation of the alarm when a predetermined event is generated.

Preferred Embodiments

The present invention will be described in detail with reference to the accompanying drawings.

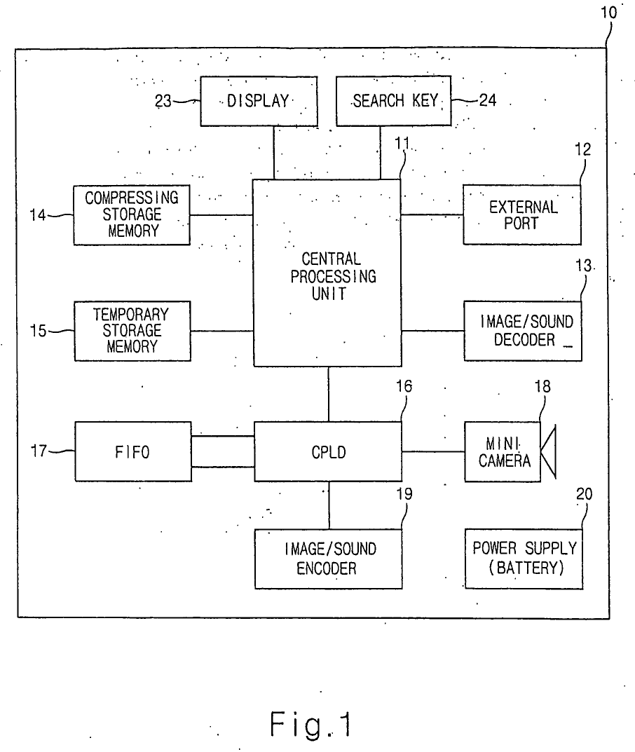

FIG. 1 is a block diagram illustrating a portable surveillance camera 10 according to an embodiment of the present invention.

A central processing unit 11, an image/sound decoder 13, a mini-camera 18, a temporary storage memory 15, a compressing storage memory 14 and an external port 12 perform general camera operations of capturing image, performing a predetermined image processing, and compressing and storing data.

The central processing unit 11 receives image and sound from a video camera which is additionally installed in the outside through the image/sound decoder 13 or receives image from the mini-camera 18 or receives image/sound data through the external port 12. Then, the central processing unit 11 temporarily stores the data in the temporary storage memory 15, and compresses and stores the data in the compressing storage memory 14.

In this way, the compressed data are restored in the central processing unit 11 to be searched in an external personal computer 31 connected to the external port 12 or the data may be stored by using other external storage devices 32. Here, to embody the functions of the central processing unit 11, a common central processing unit CPU is widely used or the design can be variously modified when a compressing codec chip is combined in the central processing unit or only the compressing codec chip is used.

The input/output speed of multimedia data is required to be set so that the multimedia data may be immediately outputted to an image/sound encoder 19 through a system where the multimedia data received from the mini-camera 18 such as a CMOS camera, a pin-hole camera or a CCD camera and external the adapter 37 for the power supply 20 using a commercial power.

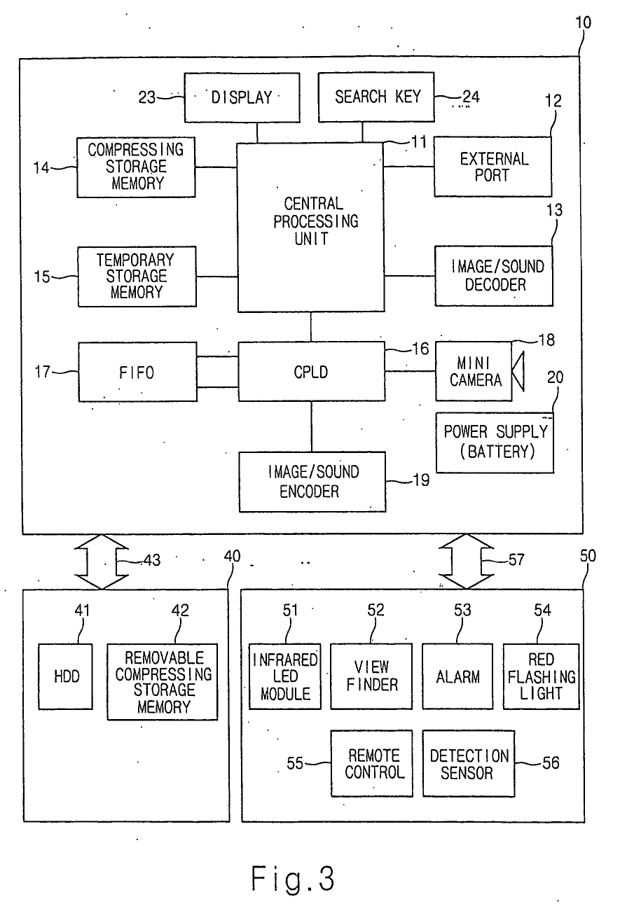

FIG. 3. is a block diagram illustrating an extensible function of a portable surveillance camera according to an embodiment of the present invention. In FIG. 3, an extension memory device 40 and a function extension device 50 are exemplified which are added in the portable surveillance camera 10 to extend devices. When storage capacity larger than that of the storage memories 14, 15 embedded in the portable surveillance camera 10 is required, a HDD 41 as a hard disk and a removable compressing storage memory can be added with a connection port 43.

A connection port 57 is positioned which is connectable to an infrared LED module 51 for night photography, a view finder 52 for more facilitating photography for easily grasping the boundary of image captured by a mini-camera, an alarm 53 for making warning broadcasting or alarm sound in generation of events, a red flashing light 54 for providing an alarm light, a remote control 55 for controlling the portable surveillance camera 10 or performing a remote control of the alarm 53 or the red flashing light 54, and a detection sensor 56 for detecting movement, heat, fire, gas and door open and close states, thereby extending its function.

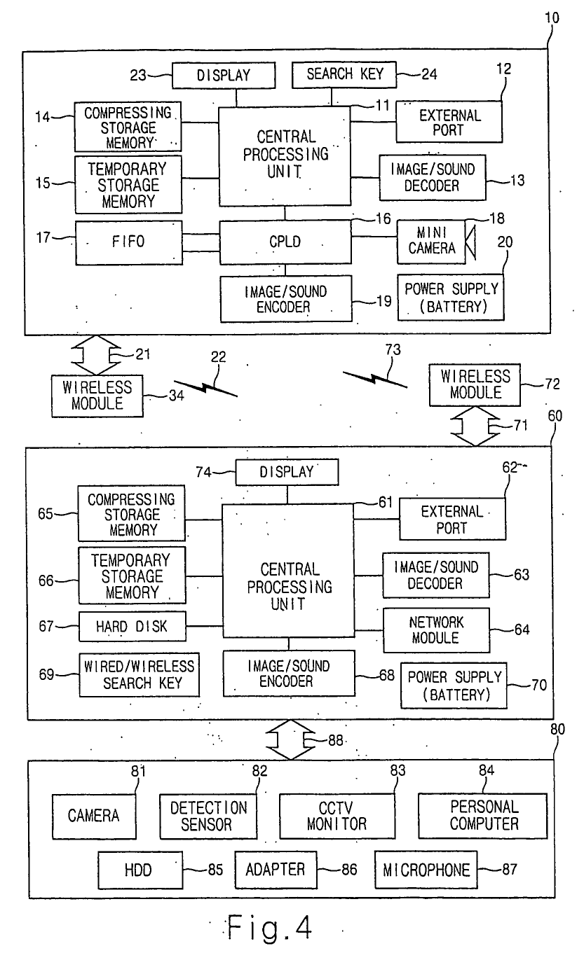

FIG. 4 is a wireless connection diagram illustrating a portable surveillance camera and a control device according to an embodiment of the present invention. A control device 60 of FIG. 4 can be configured to include basic functions of the portable surveillance camera 10 if necessary. Various functions performed in the portable surveillance camera 10 can be performed also in the control device 60 so that data can be stored or processed in the control device 60 as well as the control device 60 is connected to external equipments so that various functions can be extended.

In FIG. 4, various external extension devices 80 are shown which are connectable through the control device 60 and a connection unit 88. As shown in FIG. 4, the portable surveillance camera 10 is configured to perform wireless communications 22 and 73 between the portable surveillance camera 10 and the control device 60. Through the wireless configuration, multimedia data such as image, sound, event signals and control signals can be exchanged between the portable surveillance camera 10 and the control device 60, and the data stored in the portable surveillance camera 10 can be moved into the control device 60, searched in the control device 60 or surveillance image and sound can be monitored in the control device 60 on real time. As a result, various functions can be embodied.

For preferred embodiments, the control device 60 comprises a central processing unit 61, an external port 62, an image/sound decoder 63, a compressing storage memory 65, a temporary storage memory 66, an image/sound encoder 68, a power supply 70 (in case of the control device, the power is not required to be a battery), and a display 74. The control device 60 further comprises a hard disk 67 for storing data of high capacity, a network module 64, and a wired/wireless search key 69. The network module 64, which is selected from a wire network modem, a wireless network modem, a CDMA module and a GSM module, provides a network connection function with a LAN, an internet network or a communication network, and is configured to be embedded or be removable. The wired/wireless search key 69 enables a user to search data stored in the control device 60 or data stored in the portable surveillance camera 10 on real time. Corresponding to input of the wired/wireless search key 69, the display 74 comprising a LCD panel represents data on a screen so that a user ma search data through input of search keys.

As the external extension device 80 for extending functions of the control device 60, a surveillance camera 81, a detection sensor 82, a CCTV monitor 83, a personal computer 84, a HDD 85, an adapter 86 and a microphone 87 for extension of functions of the portable surveillance camera are used. The HDD 85 of the external extension devices 80 may be directly connected to the control device 60 or connected (88) to the control device 60 through the LAN or the internet with the network module 64 embedded in the control device 60. As a result, the HDD 85 can be used a remote storage device to store or back up images surveilled by the portable surveillance camera 10 or the control device 60 or multimedia data stored in the control device 60 in a remote location which does not comprise the control device 60 or the portable surveillance camera 10. The wireless communications 22 and 73 between the portable surveillance camera 10 and the control device 60 are connected to the wireless modules 34 and 72 so that the multimedia data of the portable surveillance camera 10 are stored in the control unit 60 and searched remotely.

Data can be exchanged through the network connection unit 67 in the control device. For example, data are provided to a storage device or a PC which is located at a long distance or data are inputted from a web camera or a PC camera which is located at a long distance. Also, the personal surveillance camera can be connected to a personal portable terminal such as a PDA or a cellular phone through the network, and event images generated from the portable surveillance camera and/or the control device are transmitted to the connected portable terminal for remote surveillance.

In addition, the control device can be embodied as an individual equipment of a stand-alone type or configured to perform the same function with a general personal computer PC. In this case, all functions of the above-described control device 60 utilize hardware of the general PC, and software for performing functions of each module is mounted in the above-described control device. Otherwise, a hardware module, which is formed as a circuit board in a slot of the general PC, is configured to be mounted in the control device. The control device, which is a type of the general PC having one or more ports connectable to external equipment, comprises the above-described wireless module 72 which is attached to one of the ports and configured to enable wireless transmission and reception of data. In this configuration, a sizable proportion of resources of the conventional PC can be used so that cost is reduced than when an individual control device is embodied. As a result, much utilization of the above-described control device is expected in many persons who intend to utilize a personal surveillance system.

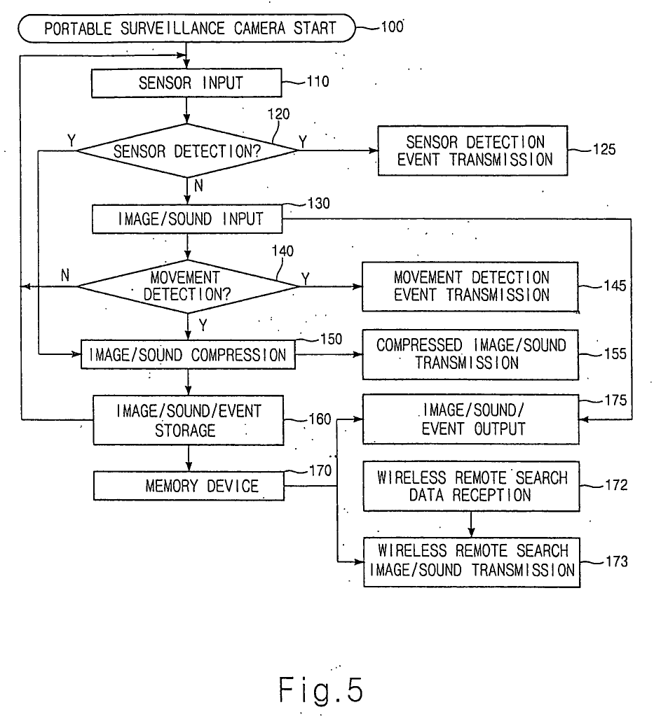

FIG. 5 is a flow chart illustrating the operation of a portable surveillance camera according to an embodiment of the present invention. If an operating signal is inputted in a sensor (110) after the portable surveillance camera starts operating (100), whether a predetermined event is generated is judged through a sensing signal of the sensor (120) so that a signal for representing an event detected in the sensor may be transmitted (125). When an event is not detected in the sensor, image/sound captured in the surveillance camera are received (130) so that whether there is movement in a surveillance range of the surveillance camera is judged (140). If the movement is detected, the movement detecting event is transmitted to the control device (145). Then, the image/sound are compressed (150), and the image/sound/event information is stored (160) or may be transmitted to the control device (155) if necessary. Also, it is possible to output information on image/sound/event (175) based on data stored in the memory device. In case of reception of data for requesting wireless remote search (172), it is possible to transmit image/sound data for wireless remote search (173).

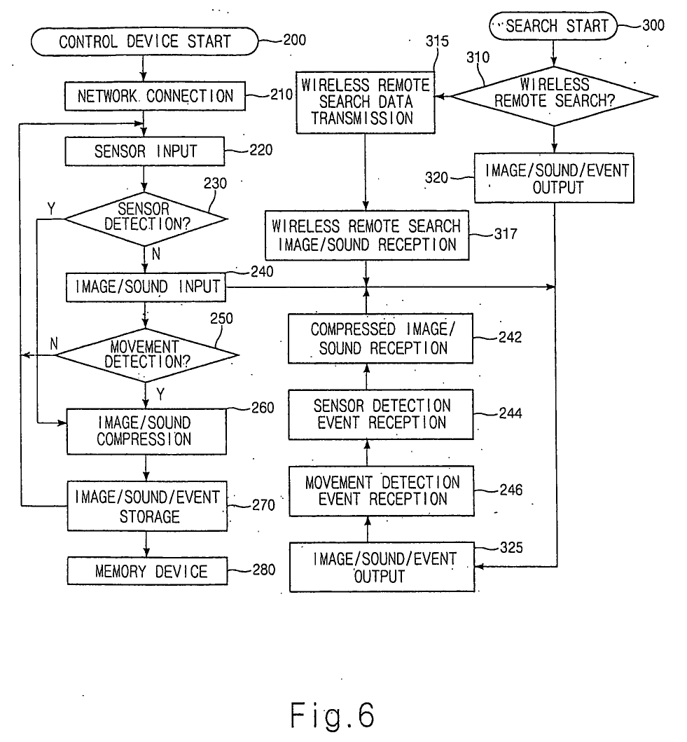

FIG. 6 is a flow chart illustrating the operation of a control device according to an embodiment of the present invention. If the control device starts operating (200), the network can be connected. The process comprising sensor input (220), sensor detection (230), image/sound input (240), movement detection (250), image/sound compression (260), image/sound/event storage (270) and memory device storage (280) is similar to that of the portable surveillance camera 10. In case of search of the stored data, if the search starts (300), whether the search is wireless remote search or not is judged (310). Then, when the search is the wireless remote search, request data are transmitted to the portable surveillance camera (315), and data on image/sound for the wireless remote search is received (317) after wait for response of the surveillance camera. However, in case not of the wireless remote search but of self-stored data search (320), the searched data on image/sound/event are outputted (325).

In the operation of the control device 60, the compressed image/sound 9242), the event detected in the sensor (244) or the movement detecting event which are transmitted from the portable surveillance camera 10 are also received.

A portable surveillance camera and a personal surveillance system using the same according to an embodiment of the present invention is susceptible to various modifications and alternative forms in the technical thought of the invention, and is not limited to the particular forms disclosed. Whether each element of the particular forms disclosed is comprised in one form or is configured to be separated from each other is not important in determination of a range of the technical thought of the present invention but is simple modification of the invention.

Additionally, specific embodiments of the invention have been shown by way of example in the drawings and described in detail herein. However, it should be understood that the invention is not limited to the range of the technical thought of the invention. Rather, the invention covers all modifications, equivalents, and alternatives falling within the spirit and scope of the invention as defined in the appended claims.

### INDUSTRIAL APPLICABILITY

In a portable surveillance camera and a personal surveillance system using the same, a user can carry a portable surveillance camera regardless of places so that it is easy to install the portable surveillance camera in a predetermined place such as an office, a house or other places. As a result, a person who frequently moves easily surveilles an area that the person intends to surveille without any installment or operation of a high-priced system for surveillance.

Also, it is easy to perform various functions such as search of surveillance documents by easily connecting devices for extension of various functions to the personal surveillance system and the personal surveillance. When a portable surveillance camera installed in a predetermined surveillance area is lost or stolen, surveillance data right before loss or stealing of the camera are stored in the control device through wireless transmission so that the surveillance data can be safely preserved and also loss and stealing states can be grasped.

Additionally, since the control device configured to communicate with the portable surveillance camera wirelessly includes a network connection function, a scene that the portable surveillance camera or the control device surveilles can be monitored at a remote place wherever there is a network such as a LAN or an internet, and it is possible to control the portable surveillance camera or the control device or to back up or store data at a remote place. This configuration relieves a user from inconvenience where the user directly accesses the portable surveillance camera or the control device installed in a predetermined surveillance area to search surveillance data, thereby facilitating more convenient operation of the system. What is claimed is:

1. A personal surveillance system using a portable surveillance camera, comprising:
one or more portable surveillance camera having a wireless communication function and capable of capturing a required image; and
a control device for collecting the image captured from the portable surveillance camera through wireless communication and storing the collected image to perform a predetermined signal processing.

2. The personal surveillance system according to claim 1, wherein the portable surveillance camera comprises:
a camera unit for capturing the required image to perform a predetermined image processing; and
a wireless module for providing a wireless communication function with the control device.

3. The personal surveillance system according to claim 2, wherein the camera unit comprises:
a mini-camera for capturing an image;
a temporary storage memory for temporarily storing data outputted from the mini-camera;
a central processing unit for compressing the data temporarily stored in the temporary storage memory;
a compressing storage memory for storing data compressed by the central processing unit;
a display for representing the stored image and a state of the camera in a screen;
a searching unit for searching the data by representing the stored data through the display; and
an external port for storing the data in an external storage unit or for providing connection to an external unit in order to download, search, store or process the data, which is stored in the compressing storage memory, in a personal computer.

4. The personal surveillance system according to claim 3, wherein the camera unit further comprises an infrared LED for providing a light source for night photographing.

5. The personal surveillance system according to claim 2, wherein the camera unit is capable of regulating a time interval for capturing an image to prevent power consumption.

6. The personal surveillance system according to claim 2, wherein the camera unit has an automatic focus control function with respect to an object located at a distance of more than 40 cm.

7. The personal surveillance system according to claim 1, wherein the control device comprises:
a wireless module for providing a wireless communication function with the portable surveillance camera;
a searching unit for accessing the portable surveillance camera through the wireless module to search the data stored in the portable surveillance camera remotely;
a storage unit for storing data received from the portable surveillance camera through the wireless module; and
a display for representing the stored image and a state of the control device.

8. The personal surveillance system according to claim 7, wherein the control device further comprises a network connection unit for enabling inter-access with external apparatus connected to a network to transmit data to a storage unit or a PC which is located at a long distance through the network connection unit or to transmit an event image generated from the portable surveillance camera and/or the control device to a personal portable terminal by being connected to the personal portable terminal such as a PDA or a cellular phone for remote surveillance or to input data from a web camera or a PC camera which is located at a long distance.

9. The personal surveillance system according to claim 8, wherein the network connection unit is selected from one or more from a wire network connection unit, a CDMA module, a GSM module and a wireless network modem, and is configured to be embedded or removable in the control device.

10. The personal surveillance system according to claim 7, wherein the control device further comprises:
a temporary storage memory for temporarily storing data inputted through the wireless module;
a central processing unit for compressing data temporarily stored in the temporary storage memory;
a compressing storage memory for storing the data compressed by the central processing unit; and
an external port for storing the data in an external storage unit or providing connection to an external unit to download, search, store or process the data, which is stored in the compressing storage memory, in an external personal computer.

11. The personal surveillance system according to claim 10, wherein the control device further comprises an image/sound decoder for decoding a received image and/or sound data,
the temporary storage memory temporarily stores the image and/or sound data,
the central processing unit compresses the image and/or sound data, and
the compressing storage memory stores the compressed image and/or sound data.

12. The personal surveillance system according to claim 7, wherein the control device further comprises an image/sound encoder for outputting data to an image processing unit.

13. The personal surveillance system according to claim 1, wherein the control device is a general PC having one or more ports connectable to an external unit, and the wireless module is attached to the port for wireless transmission and reception.

14. The personal surveillance system according to claim 1, further comprises an alarm wired or wireless connectable to the portable surveillance camera or the control device at a close distance.

15. The personal surveillance system according to claim 14, wherein the portable surveillance camera or the control device further comprises:
a sensor connection unit for connecting at least one or more sensors selected from movement, fire, heat, gas, door open and close sensors; and
a unit for processing a signal inputted from the sensor and generating an event signal to provide a signal for controlling the operation of the alarm when a predetermined event is generated.

16. The personal surveillance system according to claim 14, wherein the alarm further comprises a unit for generating an event while interworking with an external switch unit such as a bell.

17. The personal surveillance system according to claim 14, wherein the alarm further comprises a unit for controlling setting/cancellation of the alarm function with a wireless remote control.

18. A portable surveillance camera applied to a personal surveillance system, comprising:
a camera unit for capturing a required image to perform a predetermined image processing; and
a wireless module for transmitting and receiving wireless data externally.

19. The portable surveillance camera according to claim 18, wherein the camera unit comprises:
a mini-camera for capturing an image;
a temporary storage memory for temporarily storing data outputted from the mini-camera;
a central processing unit for compressing data temporarily stored in the temporary storage memory;
a compressing storage memory for storing the data compressed by the central processing unit;.
a display for representing the collected image and a state of the camera on a screen;
a searching unit for representing the stored data through the display to search the data; and
an external port for storing the data in an external storage unit or providing connection to an external unit to download, search, store or process the data, which is stored in the compressing storage memory, in a personal computer.

20. The portable surveillance camera according to claim 19, wherein the camera unit further comprises an image/sound decoder for decoding a received image and/or sound data,
the temporary storage memory temporarily stores the image and/or sound data,
the central processing unit compresses the image and/or sound data, and
the compressing storage memory stores the compressed image and/or sound data.

21. The portable surveillance camera according to claim 19, wherein the camera unit further comprises:
a FIFO memory for performing a buffer function;
a CPLD module for temporarily storing and transmitting the data in the FIFO to adjust data input and output speed so that the data is read through an externally installed monitor; and
an image/sound encoder for outputting data received from the CPLD module to an external image processing unit.

22. The portable surveillance camera according to claim 19, wherein the camera unit further comprises a removable chipset memory for storing the compressed data.

23. The portable surveillance camera according to claim 19, wherein the camera unit further comprises a removable view finder for easily displaying a boundary of images captured by the mini-camera.

24. The portable surveillance camera according to claim 19, wherein the camera unit further comprises an infrared LED for providing a light source for night photographing.

25. The portable surveillance camera according to claim 19, wherein the camera unit is capable of regulating a time interval for capturing an image to prevent power consumption.

26. The portable surveillance camera according to claim 19, wherein the camera unit has an automatic focus control function with respect to an object located at a distance of more than 40 cm.

27. The portable surveillance camera according to claim 18, further comprising:
a sensor connection unit for connecting at least one or more sensors selected from movement, fire, heat, gas, door open and close sensors; and
a unit for processing a signal inputted from the sensor and generating an event signal to provide a signal for controlling the operation of the alarm when a predetermined event is generated.
